(19) United States
(12) Patent Application Publication
(10) Pub. No.: US 2016/0006018 A1
(43) Pub. Date: Jan. 7, 2016

(54) ELECTRODE SURFACE ROUGHNESS CONTROL FOR SPRAY COATING PROCESS FOR LITHIUM ION BATTERY

(71) Applicant: APPLIED MATERIALS, INC., Santa Clara, CA (US)

(72) Inventors: Fei WANG, Fremont, CA (US); Victor PEBENITO, San Jose, CA (US); Hooman BOLANDI, San Jose, CA (US); Connie P. WANG, Mountain View, CA (US)

(73) Assignee: APPLIED MATERIALS, INC., Santa Clara, CA (US)

(21) Appl. No.: 14/770,441

(22) PCT Filed: Mar. 3, 2014
(86) PCT No.: PCT/US2014/019807

§ 371 Date: Aug. 25, 2015

Related U.S. Application Data
(60) Provisional application No. 61/776,103, filed on Mar. 11, 2013.

(51) Int. Cl. H01M 4/04; H01M 4/1391; H01M 4/1397; H01M 4/36

(52) U.S. Cl. CPC H01M 4/0471; H01M 4/0404; H01M 4/0419; H01M 4/366; H01M 4/1391; H01M 4/1397; H01M 2004/021

(57) ABSTRACT

A method and apparatus for fabricating energy storage devices and device components is provided. It has been found that spraying of slurries comprising electro-active materials onto a flexible substrate and subsequently exposing the substrate to an increasing temperature gradient leads to the deposition of a dry or mostly dry film having reduced surface roughness. The increasing temperature gradient may result from a plurality of heated rollers over which the substrate traverses wherein each heated roller is heated to a temperature greater than the previous heated roller leading to the deposition of a dry or mostly dry film having a relatively smooth surface with low porosity. Deposition of a dry or mostly dry film eliminates the need for large and costly drying mechanism thus reducing both the cost and footprint of the apparatus.

### BACKGROUND

1. Field

Implementations of the present invention relate generally to high-capacity energy storage devices, and more specifically, to methods, device components, systems and apparatus for fabricating energy storage devices and device components.

2. Description of the Related Art

High-capacity energy storage devices, such as lithium-ion (Li-ion) batteries, are used in a growing number of applications, including portable electronics, medical, transportation, grid-connected large energy storage, renewable energy storage, and uninterruptible power supply (UPS).

Li-ion batteries typically include an anode electrode, a cathode electrode and a separator positioned between the anode electrode and the cathode electrode. The separator is an electronic insulator which provides physical and electrical separation between the cathode and the anode electrodes. The separator is typically made from micro-porous polyethylene and polyolefin, and is applied in a separate manufacturing step.

For most energy storage applications, the charge time and capacity of energy storage devices are important parameters. In addition, the size, weight, and/or expense of such energy storage devices can be significant limitations.

One method for manufacturing anode electrodes and cathode electrodes for energy storage devices is principally based on slit coating of viscous powder slurry mixtures of cathodically or anodically active material onto a conductive current collector followed by prolonged heating to form a dried cast sheet and prevent cracking. The thickness of the electrode after drying which evaporates the solvents is finally determined by compression or calendering which adjusts the density and porosity of the final layer. Slit coating of viscous slurries is a highly developed manufacturing technology which is very dependent on the formulation, formation, and homogenization of the slurry. The formed active layer is extremely sensitive to the rate and thermal details of the drying process.

Among other problems and limitations of this technology is the slow and costly drying component which requires both a large footprint (e.g., up to 50 meters long) and an elaborate collection and recycling system for the evaporated volatile components. Many of these are volatile organic compounds which additionally require an elaborate abatement system. Further, the resulting electrical conductivity of these types of electrodes also limits the thickness of the electrode and thus the volume of the electrode.

Accordingly, there is a need in the art for methods, systems and apparatus for more cost effectively manufacturing faster charging, higher capacity energy storage devices that are smaller, lighter, and can be manufactured at a high production rate without detrimentally effecting the environment.

### SUMMARY

Implementations of the present invention relate generally to high-capacity energy storage devices, and more specifically, to methods, device components, systems and apparatus for fabricating energy storage devices and device components. In one implementation a method for forming an electrode structure is provided. The method comprises spraying an electro-active material over a flexible conductive substrate, transferring the flexible conductive substrate having an electro-active material deposited thereon over a first heated roller having a first temperature and then transferring the flexible conductive substrate having the electro-active material deposited thereon over a second heated roller having a second temperature, wherein the second temperature is greater than the first temperature and the electro-active material comprises a cathodically active material.

### BRIEF DESCRIPTION OF THE DRAWINGS

So that the manner in which the above recited features of the present invention can be understood in detail, a more particular description of the invention, briefly summarized above, may be had by reference to implementations, some of which are illustrated in the appended drawings. It is to be noted, however, that the appended drawings illustrate only typical implementations of this invention and are therefore not to be considered limiting of its scope, for the invention may admit to other equally effective implementations.

FIG. 1A is a schematic diagram of a partial battery cell bi-layer having one or more electrode structures formed according to implementations described herein;

FIG. 1B is a schematic diagram of a partial battery cell having one or more electrode structures formed according to implementations described herein;

FIG. 2 is a schematic partial cross-sectional view of one implementation of a spray module having heated rollers according to implementations described herein; and

FIG. 3 is a flow diagram of a method of forming an electrode according to implementations described herein.

To facilitate understanding, identical reference numerals have been used, where possible, to designate identical elements that are common to the figures. It is contemplated that elements disclosed in one implementation may be beneficially utilized on other implementations without specific recitation.

### DETAILED DESCRIPTION

Implementations of the present invention relate generally to high-capacity energy storage devices, and more specifically, to methods, device components, systems and apparatus for fabricating energy storage devices and device components. In certain implementations it has been found that spraying of slurries comprising electro-active materials onto a flexible substrate and subsequently exposing the substrate to an increasing temperature gradient leads to the deposition of a dry or mostly dry film having low porosity and reduced surface roughness/increased smoothness. The increasing temperature gradient may result from a plurality of heated rollers over which the substrate traverses wherein each heated roller is heated to a temperature greater than the previous heated roller leading to the deposition of a dry or mostly dry film having a relatively smooth surface with low porosity. Deposition of a dry or mostly dry film eliminates the need for large and costly drying mechanism thus reducing both the cost and footprint of the apparatus.

Deposition of active materials having reduced surface roughness and lower porosity are desirable for several reasons. Dense packing of active materials is desirable for achieving electrodes having less resistance and high capacity. Generally, after deposition of electrode forming materials, the electrode forming materials are exposed to a calendering process to achieve a desired porosity. The lower the initial porosity after deposition of the electrode forming materials, the easier the calendering process, also there is effort on resulting optimal porosity right after deposition in order to eliminate this step to be cost effective. Reduced surface roughness and increased smoothness are also important since a rougher surface may lead to uneven current density across the electrode thus adversely affecting battery performance.

Certain implementations of the invention provide methods and apparatus for surface roughness control of electrodes produced by spray coating methods. Deposition of electrode forming materials on a heated substrate by spray coating provides instantaneous drying resulting in a crack free thick coating with limited binder migration as compared with conventional slot die coating methods. However, due to the quick drying of the spray droplets as they contact the heated substrate the droplets pile together resulting in coatings that exhibit increased surface roughness and high porosity. The degree of surface roughness is generally process dependent and may depend on such factors as the temperature of the substrate/hot roller, the flow rate of the electrode forming materials, and the solid content of the electrode forming materials. This increased surface roughness may adversely affect the electrical performance of the final battery structure. Further, this increased surface roughness also presents problems for double sided coating of substrates which is a desired goal for most current lithium ion battery manufacturing processes. For example, increased surface roughness/high porosity leads to inefficient drying of the back side coating resulting in process inconsistencies and added complexities.

In certain implementations described herein, surface roughness is reduced by controlling the drying speed of the material deposited during the deposition step. The drying speed of the material may be controlled using multiple stages of coating and drying processes to provide electrodes having a smooth surface with low porosity which are comparable with electrodes produced using conventional slot die coating methods while at same time providing fast drying, crack free and with limited binder migration issues.

In certain implementations, the electrode forming slurry is sprayed on a substrate travelling over a low temperature roller. The low temperature roller is heated to a temperature range such that the deposited material remains on the substrate without dripping at moderate drying speed. Exemplary temperatures for the low temperature roller are between about 60 degrees Celsius to about 90 degrees Celsius. The substrate will then travel over a second heated roller wherein the second roller is heated to a temperature configured to further dry the coating. In certain implementations, involving a dual-sided coating process and/or a change of direction where the deposited material contacts a roller, the second roller is heated to a temperature to further dry the coating to a temperature such that the coating can contact the roller without damage to the deposited material. Finally, the substrate will travel over a high temperature roller heated to a temperature range such that any remaining solvent will be removed from the deposited material. Exemplary temperatures for the high temperature roller are between about 120 degrees Celsius and about 130 degrees Celsius. In certain implementations, additional heaters may be used in addition to the heated rollers to increase the drying. Exemplary additional heaters include infrared (IR) heaters and heated air.

As used herein, “spray deposition techniques” include, but are not limited to, hydraulic spray techniques, atomizing spray techniques, electrospray techniques, plasma spray techniques, pneumatic spray techniques, and thermal or flame spray techniques.

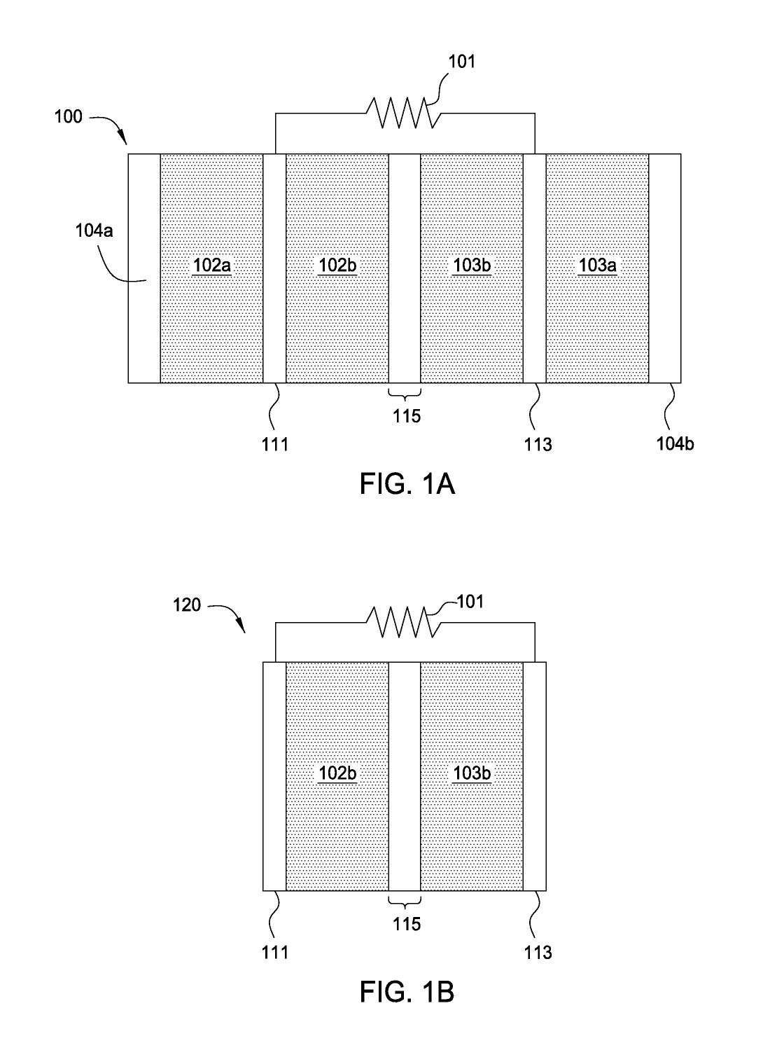

Certain implementations described herein include the manufacturing of battery cell electrodes by depositing electro-active materials using spray deposition techniques to form anodically active or cathodically active layers on substrates which function as current collectors, for example, copper substrates for anodes and aluminum substrates for cathodes. For bi-layer battery cells and battery cell components, opposing sides of the processed substrate may be simultaneously processed to form a bi-layer structure. Exemplary implementations of anode structures and cathode structures which may be formed using the implementations described herein are described in FIGS. 1, 2A-2D, 3, 5A and 5B and corresponding paragraphs [0041]-[0066] and [0094]-[0100] of commonly assigned U.S. patent application Ser. No. 12/839,051, (Attorney Docket No. APPM/014080/EES/AEP/ESONG), filed Jul. 19, 2010, to Bachrach et al., titled COMPRESSED POWDER 3D BATTERY ELECTRODE MANUFACTURING, now published as US 2011/0129732.

As deposited, the electro-active materials may comprise nanoscale sized particles and/or micro-scale sized particles. The electro-active materials may be deposited over three-dimensional conductive porous structures. The three-dimensional conductive porous structure may be formed by at least one of: a porous electroplating process, an embossing process, or a nano-imprinting process. In certain implementations, the three-dimensional conductive porous structure comprises a wire mesh structure. The formation of the three-dimensional conductive porous structure determines the thickness of the electrode and provides pockets or wells into which the electro-active powders may be deposited using the systems and apparatus described herein.

The use of various types of substrates on which the materials described herein are formed is also contemplated. While the particular substrate on which certain implementations described herein may be practiced is not limited, it is particularly beneficial to practice the implementations on flexible conductive substrates, including for example, web-based substrates, panels and discrete sheets. The substrate may also be in the form of a foil, a film, or a thin plate. In certain implementations where the substrate is a vertically oriented substrate, the vertically oriented substrate may be angled relative to a vertical plane. For example, the substrate may be slanted from between about 1 degree to about 20 degrees from the vertical plane. In certain implementations where the substrate is a horizontally oriented substrate, the horizontally oriented substrate may be angled relative to a horizontal plane. For example, the substrate may be slanted from between about 1 degree to about 20 degrees from the horizontal plane. In certain implementations, it may be beneficial to practice the implementations on non-conductive flexible substrates. Exemplary non-conductive substrates include polymeric substrates.

FIG. 1A is a schematic diagram of a partial battery cell bi-layer 100 having one or more electrode structures (anode 102a, 102b and/or cathode 103a, 103b) formed according to implementations described herein. The partial battery cell bi-layer 100 may be a Li-ion battery cell bi-layer. FIG. 1B is a schematic diagram of a partial battery cell 120 having one or more electrode structures formed according to implementations described herein. The partial battery cell bi-layer 120 may be a Li-ion battery cell bi-layer. The battery cells 100, 120 are electrically connected to a load 101 according to one implementation described herein. The primary functional components of the battery cell bi-layer 100 include anode structures 102a, 102b, cathode structures 103a, 103b, separator layers 104a, 104b, and 115, current collectors 111 and 113 and optionally an electrolyte (not shown) disposed within the region between the separator layers 104a, 104b. The anode structures 102a, 102b and cathode structures 103a, 103b may be formed according to the implementations described herein. The primary functional components of the battery cell 120 include anode structure 102b, cathode structure 103b, the separator 115, current collectors 111 and 113 and an optional electrolyte (not shown) disposed within the region between the current collectors 111, 113. A variety of materials may be used as the electrolyte, for example, a lithium salt in an organic solvent. The battery cells 100, 120 may be hermetically sealed in a suitable package with leads for the current collectors 111 and 113.

The anode structures 102a, 102b, cathode structures 103a, 103b, and separator layers 104a, 104b and 115 may be immersed in the electrolyte in the region formed between the separator layers 104a and 104b. It should be understood that a partial exemplary structure is shown and that in certain implementations, additional anode structures, cathode structures, and current collectors may be added to the structure.

Anode structure 102b and cathode structure 103b serve as a half-cell of the battery 100. Anode structure 102b may include a metal anodic current collector 111 and an active material formed according to implementations described herein. The anode structure may be porous. Other exemplary active materials include graphitic carbon, lithium, tin, silicon, aluminum, antimony, tin-boron-cobalt-oxide, and lithium-cobalt-nitride (e.g., Li₃₋₂ₓCoₓN (0.1≦x≦0.44)). Similarly, cathode structure 103b may include a cathodic current collector 113 respectively and a second active material formed according to implementations described herein. The current collectors 111 and 113 are made of electrically conductive material such as metals. The current collectors may comprise a flexible conductive material, for example, a foil. In one implementation, the anodic current collector 111 comprises copper and the cathodic current collector 113 comprises aluminum. The separator 115 is used to prevent direct electrical contact between the components in the anode structure 102b and the cathode structure 103b. The separator 115 may be porous.

Active materials on the cathode side of the battery cell 100, 120 or positive electrode, may comprise a lithium-containing metal oxide, such as lithium cobalt dioxide (LiCoO₂) or lithium manganese dioxide (LiMnO₂), LiCoO₂, LiNiO₂, LiNiₓCo_{y}O₂ (e.g., LiNi_{0.8}Co_{0.2}O₂) LiNiₓCo_{y}Al_{z}O₂ (e.g., LiNi_{0.8}Co_{0.15}Al_{0.05}O₂), LiMn₂O₄, LiₓMg_{y}Mn_{z}O₄ (e.g., LiMgₒ₅Mn_{1.5}O₄), LiNiₓMn_{y}O₂ (e.g., LiNi_{0.5}Mn_{1.5}O₄), LiNiₓMn_{y}Co_{z}O₂ (e.g., LiNiMnCoO₂) (NMC), lithium-aluminum-manganese-oxide (e.g., LiAlₓMn_{y}O₄) and LiFePO₄. The active materials may be made from a layered oxide, such as lithium cobalt oxide, an olivine, such as lithium iron phosphate, or a spinel, such as lithium manganese oxide. In non-lithium implementations, an exemplary cathode may be made from TiS₂ (titanium disulfide). Exemplary lithium-containing oxides may be layered, such as lithium cobalt oxide (LiCoO₂), or mixed metal oxides, such as LiNiₓCo₁₋₂ₓMnO₂, LiNi_{0.5}Mn_{1.5}O₄, Li(Ni_{0.8}Co_{0.15}Al_{0.05})O₂, LiMn₂O₄. Exemplary phosphates may be iron olivine (LiFePO₄) and it is variants (such as LiFe₁₋ₓMgPO₄), LiMoPO₄, LiCoPO₄, LiNiPO₄, Li₃V₂(PO₄)₃, LiVOPO₄, LiMP₂O₇, or LiFe_{1.5}P₂O₇. Exemplary fluorophosphates may be LiVPO₄F, LiAlPO₄F, Li₅V(PO₄)₂F₂, Li₅Cr(PO₄)₂F₂, Li₂CoPO₄F, or Li₂NiPO₄F. Exemplary silicates may be Li₂FeSiO₄, Li₂MnSiO₄, or Li₂VOSiO₄. An exemplary non-lithium compound is Na₅V₂(PO₄)₂F₃.

Active materials on the anode side or negative electrode of the battery cell 100, 120, may be made from materials such as, for example, graphitic materials and/or various fine powders, and for example, microscale or nanoscale sized powders. Additionally, silicon, tin, or lithium titanate (Li₄Ti₅O₁₂) may be used with, or instead of, graphitic materials to provide the conductive core anode material. Exemplary cathode materials, anode materials, and methods of application are further described in commonly assigned United States Patent Application Publication No. US 2011/0129732, filed Jul. 19, 2010 titled COMPRESSED POWDER 3D BATTERY ELECTRODE MANUFACTURING, and commonly assigned United States Patent Application Publication No. US 2011/0168550, filed Jan. 13, 2010, titled GRADED ELECTRODE TECHNOLOGIES FOR HIGH ENERGY LITHIUM-ION BATTERIES.

It should also be understood that although a battery cell bi-layer 100 is depicted in FIGS. 1A and 1B, the implementations described herein are not limited to Li-ion battery cell bi-layer structures. It should also be understood, that the anode and cathode structures may be connected either in series or in parallel.

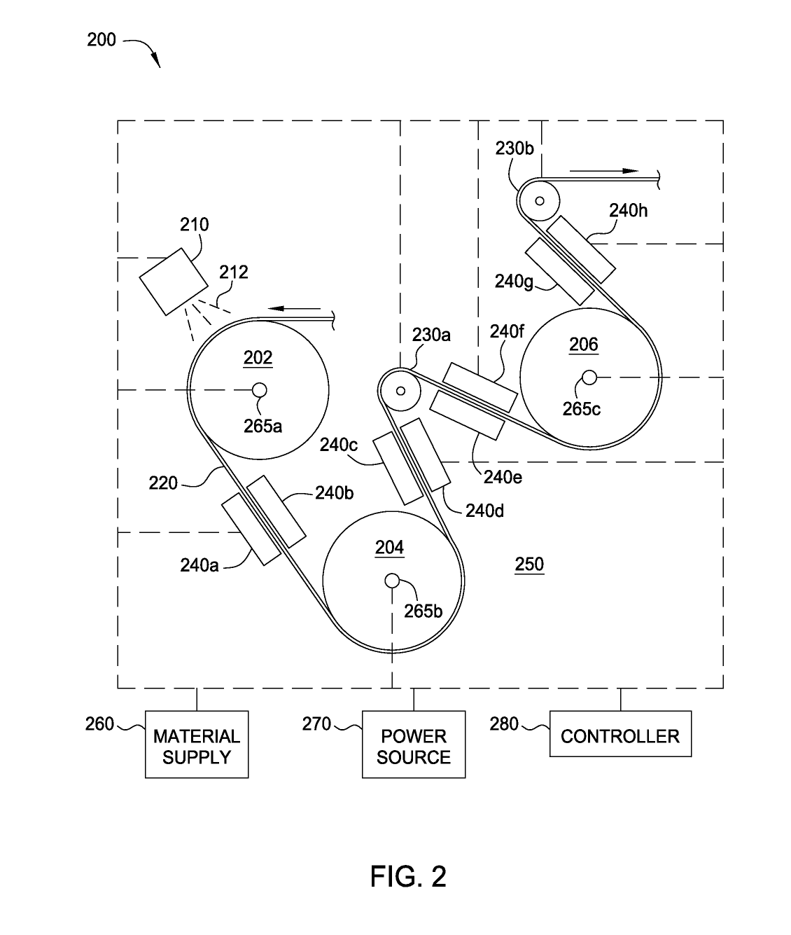

FIG. 2A is a schematic partial cross-sectional view of one implementation of a spray module 200 having a series of heated rollers 202, 204, 206 and a spray dispenser assembly 210 according to implementations described herein. The spray module 200 is configured to deposit electro-active material over a flexible substrate 220. As depicted in FIG. 2A, the spray module 200 comprises a chamber body (not shown), a plurality of heated rollers 202, 204, 206 for creating a temperature gradient, at least one spray dispenser assembly 210 for directing electro-active material 212 toward the flexible substrate 220, a plurality of optional intermediate transfer rollers 230a, 230b for supporting and transferring the flexible substrate 220, and a plurality of optional heaters 240 (shown as 240a, 240b, 240c, 240d) for drying the electro-active material.

The chamber body has a chamber inlet (not shown) for entry of the flexible substrate 220 into a processing region 250 of the spray module 200 and a chamber outlet (not shown) for egress of the flexible substrate 220 from the processing region 250.

The spray dispenser assembly 210 may be positioned adjacent to any of the heated rollers 202, 204, 206. As depicted in FIG. 2, the spray dispenser assembly 210 is positioned above the first heated roller 202 for depositing electro-active material on a first side of the flexible substrate 220. Although not shown, it should be understood that additional spray dispenser assemblies may be positioned to deposit electro-active materials on the opposing side of the flexible substrate 220. The spray dispenser assembly 210 may be positioned to deposit electro-active material 212 on the flexible substrate 220 as the flexible substrate 220 is transferred over the first heated roller 202. Thus, in certain implementations, the flexible substrate 220 may be transferred over the first heated roller 202 heated to a first temperature while simultaneously spraying the electro-active material 212 over the flexible substrate 220 using the spray dispenser assembly 210, transferring the flexible substrate 220 over the second heated roller 204 heated to a second heated temperature, and transferring the flexible substrate 220 over the third heated roller 206 heated to a third temperature. Although only one spray dispenser assembly 210 and three heated rollers 202, 204, 206 are depicted, it should be understood that any number of spray dispensers and heated rollers may be used to achieve the desired deposition of electro-active material.

The spray module may be coupled with a fluid supply 260 for supplying precursors, processing gases, processing materials such as cathodically active particles, anodically active particles, binders, solvents propellants, and cleaning fluids to the components of the spray module 200.

The heated rollers 202, 204, 206 may be heated by an internal heating mechanism 265a, 265b, 265c coupled with a power source 270. Exemplary internal heating mechanisms include heating coils, internal heating rods spaced at intervals, and heated fluid. The heated rollers 202, 204, 206 may be heated to any temperature that will dry the materials sprayed onto the flexible substrate 220. For example, the heated rollers 202, 204, 206 may be each individually heated to a temperature that dissolves solvents present in the electro-active material mixture sprayed from the spray dispenser assembly 210. The temperature of the heated rollers 202, 204, 206 may be each individually selected such that the any liquids (e.g., solvents) present in the electro-active material mixture evaporate prior to contacting the flexible substrate 220 or evaporate while in contact with the heated flexible substrate 220.

The heated rollers 202, 204, 206 may be configured to form an increasing temperature gradient with a temperature that increases from the first heated roller 202 through the third heated roller 206. The heated rollers 202, 204, 206 may each be individually heated to a temperature range from about 50 degrees Celsius to about 250 degrees Celsius. The heated rollers 202, 204, 206 may be heated to a temperature from about 80 degrees Celsius to about 180 degrees Celsius. Typically the first heater roller is heated to the lowest temperature of the plurality of rollers and each subsequent roller is heated to a higher temperature relative to the previous heated roller. In certain implementations, the first heated roller 202 may be heated to a temperature range between about 60 degrees Celsius and about 90 degrees Celsius, the second heated roller 204 may be heated to a second temperature range between about 90 degrees Celsius and about 100 degrees Celsius, and the third heated roller 206 may be heated to a third temperature range between about 120 degrees Celsius and about 130 degrees Celsius.

The heated rollers 202, 204, 206 may be dimensioned to provide a sufficient surface area for drying of the sprayed materials at elevated temperatures. The heated rollers 202, 204, 206 may be of sufficient thermal mass such that the as deposited sprayed materials do not significantly cool the surface of the heated rollers 202, 204, 206. The heated rollers 202, 204, 206 are dimensioned such that the flexible substrate 220 may wrap around each heated roller 202, 204, 206 such that the flexible substrate 220 covers at least 180 degrees of the circumference of the surface of each heated roller 202, 204, 206. The flexible substrate 220 may cover at least 180 degrees or more, 200 degrees or more, 220 degrees or more, 260 degrees or more, or 300 degrees or more of circumference of the surface of each heated roller 202, 204, 206. The heated rollers 202, 204, 206 may have a diameter of at least 2 inches, 6 inches, or 12 inches and a diameter up to at least 6 inches, 12 inches, or 14 inches.

The heated rollers 202, 204, 206 may comprise any material that is compatible with process chemistries. The heated rollers 202, 204, 206 may comprise copper, aluminum, alloys thereof, or combinations thereof. The heated rollers 202, 204, 206 may be coated with another material. The heated rollers 202, 204, 206 may be coated with nylon or polymers. Exemplary polymers for coating the heated rollers include polyvinylidene fluoride (PVDF) and ethylene chlorotrifluoroethylene (ECTFE), commercially available under the trade name HALAR® ECTFE.

In certain implementations, the heated rollers 202, 204, 206 may be used to position and apply a desired tension to the flexible substrate 220 so that the spray processes can be performed thereon. The heated rollers 202, 204, 206 may have a DC servo motor, stepper motor, mechanical spring and brake, or other device that can be used to position and hold the flexible conductive substrate 220 in a desired position within the spray module 220.

A plurality of heating elements 240 (shown as 240a, 240b, 240c, 240d, 240e, 240f, 240g, 240h) may be disposed in the spray module 200. The heating elements 240 may assist in drying the materials 212 sprayed onto the substrate 220 so as to enhance adhesion of the deposition materials onto the substrate 220. In the implementation depicted in FIG. 2, a first heating element 240a may be disposed adjacent to the material dispenser assembly 210. As the deposition material 212 is sprayed onto the surface of the substrate 220, the thermal energy from the heating element 240a may assist drying and evaporate the solvent from the deposition material 212. A second heating element 240b may be disposed on the other side of the substrate 220, opposite the side where the first heating element 240a is disposed. The second heating element 240b may also assist drying the deposition material 212 sprayed onto the substrate 220. It is noted that the number, location, and configuration of the heating elements disposed in the spray module 200 may be varied as needed. As depicted in FIG. 2, a first heating element 240a and second heating element 240b may be disposed on opposing sides of the substrate 220 between the first heated roller 202 and the second heated roller 204, a third heating element 240c and a fourth heating element 240d may be disposed on opposing sides of the substrate 220 between the second heater roller 204 and the intermediate transfer roller 230a, a fifth heating element 240e and a sixth heating element 240f may be disposed on opposing sides of the substrate 220 between the intermediate transfer roller 230a and the third heated roller 206, and the seventh heating element 240g and the eighth heating element 240h may be disposed on opposing sides of the substrate 220 between the third heated roller 206 and the intermediate transfer roller 230b.

In certain implementations, the heating element 240 may provide a light radiation to the substrate 220. The light radiation from the heating element 240 may provide a thermal energy to the substrate 220 and control the substrate 220 at a temperature between about 10 degrees Celsius and about 250 degrees Celsius.

The spray module 200 may be coupled to a power source 270 for supplying power to the various components of the spray module 200. The power source 270 may be an RF or DC source. The power source 270 may be coupled with a controller 280. The controller 280 may be coupled with the spray module 200. The controller 280 may include one or more microprocessors, microcomputers, microcontrollers, dedicated hardware or logic, and a combination of the same.

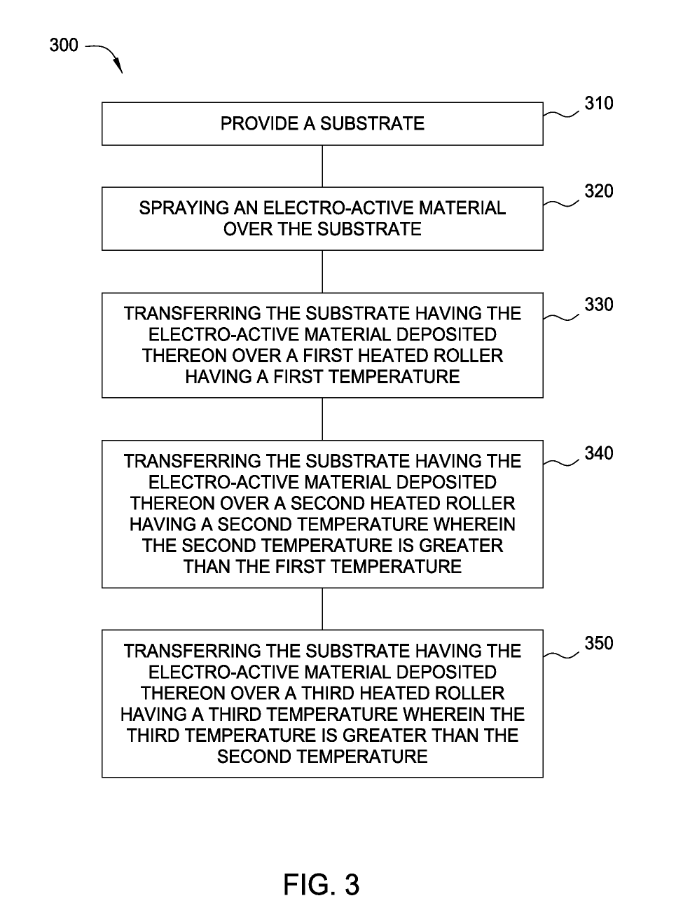

FIG. 3 is a flow diagram of a method 300 of forming an electrode according to implementations described herein. The method 300 may be performed using the spray module 200 depicted in FIG. 2. At block 310, a substrate is provided. At block 320, an electro-active material is sprayed over the substrate. At block 330, the substrate having the electro-active material deposited thereon is transferred over a first heated roller heated to a first temperature. At block 340, the substrate having the electro-active material deposited thereon is transferred over a second heated roller having a second temperature wherein the second temperature is greater than the first temperature. At block 350, the substrate having the electro-active material deposited thereon is transferred over a third heated roller heated to a third temperature greater than the second temperature.

At block 310, a substrate is provided. The substrate may be a current collector similar to either of current collector 111 and current collector 113. The substrate may be a flexible substrate similar to flexible substrate 220. In certain implementations, the substrate is a conductive substrate (e.g., metallic foil, sheet, or plate). In certain implementations, the substrate is a conductive substrate with an insulating coating disposed thereon. In certain implementations, the substrate may include a relatively thin conductive layer disposed on a host substrate comprising one or more conductive materials, such as a metal, plastic, graphite, polymers, carbon-containing polymer, composites, or other suitable materials. Examples of metals that substrate may be comprised of include aluminum (Al), copper (Cu), zinc (Zn), nickel (Ni), cobalt (Co), tin (Sn), silicon (Si), manganese (Mn), magnesium (Mg), alloys thereof, and combinations thereof. In certain implementations, the substrate is perforated.

Alternatively, the substrate may comprise a host substrate that is non-conductive, such as plastic or polymeric substrate that has an electrically conductive layer formed thereon by means known in the art, including physical vapor deposition (PVD), electrochemical plating, electroless plating, and the like. In one implementation, the substrate is a flexible host substrate. The flexible host substrate may be a lightweight and inexpensive plastic material, such as polyethylene, polypropylene or other suitable plastic or polymeric material, with a conductive layer formed thereon. In one implementation, the conductive layer is between about 10 and 15 microns thick in order to minimize resistive loss. Materials suitable for use as such a flexible substrate include a polyimide (e.g., KAPTON™ by DuPont Corporation), polyethylene terephthalate (PET), polyacrylates, polycarbonate, silicone, epoxy resins, silicone-functionalized epoxy resins, polyester (e.g., MYLAR™ by E.I. du Pont de Nemours & Co.), APICAL AV manufactured by Kanegaftigi Chemical Industry Company, UPILEX manufactured by UBE Industries, Ltd.; polyethersulfones (PES) manufactured by Sumitomo, a polyetherimide (e.g., ULTEM by General Electric Company), and polyethylene naphthalene (PEN). Alternately, the substrate may be constructed from a relatively thin glass that is reinforced with a polymeric coating.

In certain implementations, the substrate may comprise any of the conductive materials previously described including but not limited to aluminum, stainless steel, nickel, copper, and combinations thereof. The substrate may be in the form of a foil, a film, or a thin plate. In certain implementations, the substrate may have a thickness that generally ranges from about 1 to about 200 μm. In certain implementations, the substrate may have a thickness that generally ranges from about 5 to about 100 μm. In certain implementations, the substrate may have a thickness that ranges from about 10 μm to about 20 μm.

In certain implementations, the substrate is patterned to form a three dimensional structure having increased surface area. The three-dimensional structure may be formed using, for example, a nano-imprint lithography process or an embossing process.

At block 320, an electro-active material is sprayed over the substrate. The electro-active material may be sprayed onto the substrate using “spray deposition techniques” including, but not limited to, hydraulic spray techniques, pneumatic spray techniques, atomizing spray techniques, electrospray techniques, plasma spray techniques, and thermal or flame spray techniques. The electro-active material may be sprayed onto the substrate using, for example, the spray dispenser assembly 210 depicted in FIG. 2.

The electro-active material may be supplied as part of a dry powder mixture, a slurry mixture, or a gaseous mixture. The mixtures may comprise electro-active materials and at least one of a binder and a solvent.

Exemplary electro-active materials include cathodically active materials and anodically active materials. Exemplary cathodically active materials include lithium cobalt dioxide (LiCoO₂), lithium manganese dioxide (LiMnO₂), titanium disulfide (TiS₂), LiNixCo₁₋₂ₓMnO₂, LiMn₂O₄, iron olivine (LiFePO₄) and it is variants (such as LiFe₁₋ₓMgPO₄), LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, other qualified materials, composites thereof and combinations thereof. Exemplary anodically active materials include graphite, graphene hard carbon, carbon black, carbon coated silicon, tin particles, copper-tin particles, tin oxide, silicon carbide, silicon (amorphous or crystalline), silicon alloys, doped silicon, lithium titanate, any other appropriately electro-active material, composites thereof and combinations thereof.

The mixtures may further comprise a solid binding agent or precursors for forming a solid binding agent. The binding agent facilitates binding of the electro-active material with the substrate and with other particles of the electro-active material. The binding agent is typically a polymer. The binding agent may be soluble in a solvent. The binding agent may be a water-soluble binding agent. The binding agent may be soluble in an organic solvent. Exemplary binding agents include styrene butadiene rubber (SBR), carboxymethylcellulose (CMC), polyvinylidene fluoride (PVDF) and combinations thereof. The solid binding agent may be blended with the electro-active material prior to deposition on the substrate 220. The solid binding agent may be deposited on the substrate 220 either prior to or after deposition of the electro-active material. The solid binding agent may comprise a binder, such as a polymer, to hold the electro-active material on the surface of the substrate. The binding agent will generally have some electrical or ionic conductivity to avoid diminishing the performance of the deposited layer, however most binding agents are usually electrically insulating and some materials do not permit the passage of lithium ions. In certain implementations, the binding agent is a carbon containing polymer having a low molecular weight. The low molecular weight polymer may have a number average molecular weight of less than about 10,000 to promote adhesion of the nano-particles to the substrate.

The slurry or gas mixture may further comprise electro-conductive materials such as carbon black (CB) or acetylene black (AB).

Exemplary solvents include N-methyl pyrrolidone (NMP), water, or other suitable solvent.

In certain implementations, the slurry mixture has a high content of solid material. The slurry mixture may have a high solids content of more than 10% by weight, more than 20% by weight, more than 30% by weight, more than 40% by weight, more than 50% by weight, more than 60% by weight, more than 70% by weight, more than 80% by weight, more than 85% by weight or more than 90% by weight based on the total weight percent of the slurry mixture. The slurry mixture may have a high solids content in the range of 10 to 95% by weight. The slurry mixture may have a high solids content of solid material in the range of 40 to 85% by weight. The slurry mixture may have a high solids content of solid material in the range of 55 to 70% by weight. The slurry mixture may have a high solids content of solid material in the range of 65 to 70% by weight.

The solids present in the electrode forming solution comprise at least one or both of active material and conductive material. In certain implementations, the solid particles in the electrode forming solution may be nanoscale particles having a mean diameter between about 1 nanometer and 100 nanometers. In certain implementations, the solid particles in the electrode forming solution may be micro-scale particles having a mean diameter in the range of between about 1.0 μm to about 20.0 μm, such as between about 3.0 μm to about 15.0 μm.

The slurry mixture may be delivered to the substrate at a flow rate between about 0.1 ml/minute and 10 ml/minute. The slurry mixture may be delivered to the substrate at a flow rate between about 0.5 ml/minute and about 4 ml/minute. In certain implementations, where the slurry mixture is delivered using a pneumatic spray process, the slurry mixture may be delivered to the substrate at a flow rate between about 1 ml/minute and 4 ml/minute. In certain implementations, where the slurry mixture is delivered using a pneumatic spray process, the slurry mixture may be delivered to the substrate at a flow rate between about 1 ml/minute and 2 ml/minute. In certain implementations, where the slurry mixture is delivered using an electrospray process, the slurry mixture may be delivered to the substrate at a flow rate between about 0.5 ml/minute and 2 ml/minute. In certain implementations, where the slurry mixture is delivered using an electrospray process, the slurry mixture may be delivered to the substrate at a flow rate between about 0.5 ml/minute and 1 ml/minute.

During the deposition process the substrate may travel at a rate between about 4 meters/minute and about 30 meters/minute. In certain implementations, during the deposition process the substrate may travel at a rate between about 10 meters/minute and about 20 meters/minute.

At block 330, the substrate having the electro-active material deposited thereon is transferred over a first heated roller heated to a first temperature. The first heated roller may be similar to the first heated roller 202 described above. The first roller is heated to a temperature range such that the deposited material remains on the substrate without dripping at moderate drying speed. Exemplary temperatures for the low temperature roller may be between about 60 degrees Celsius to about 90 degrees Celsius. In certain implementations the spraying process of block 320 and the heating process of block 330 may be performed simultaneously or overlap partially in time (e.g., spraying electro-active material onto a substrate while the substrate travels over the heated roller.

At block 340, the substrate having the electro-active material deposited thereon is transferred over a second heated roller having a second temperature wherein the second temperature is greater than the first temperature. The second heated roller may be similar to the second heated roller 204 described above. The second roller is heated to a temperature configured to further dry the coating. The second heated roller may be heated to a second temperature range between about 90 degrees Celsius and about 100 degrees Celsius.

At block 350, the substrate having the electro-active material deposited thereon is transferred over a third heated roller heated to a third temperature greater than the second temperature. The third heated roller may be similar to the third heated roller 206 described above. The third heated roller may be heated to a temperature range such that any remaining solvent will be removed from the deposited material. Exemplary temperatures for the high temperature roller are between about 120 degrees Celsius and about 130 degrees Celsius.

Additional processing may be performed including calendering the deposited materials to achieve a desired porosity and deposition of separator materials.

### Examples

The following non-limiting examples are provided to further illustrate implementations described herein. However, the examples are not intended to be all inclusive and are not intended to limit the scope of the implementations described herein.

A slurry composition having 65 wt. % solid content resulting in a final film composition comprising about 4 wt. % PVDF, about 3.2 wt. % carbon black (CB), and about 92.8 wt. % nickel-manganese-cobalt was used for the following examples. An aluminum foil substrate was transferred over a heated roller at a rate of 4 meters/minute while the slurry mixture was pneumatic-sprayed at the flow rate listed in Table I. The roller was heated to the temperature listed below in Table I. Porosity was calculated by the weight in certain volume and compared with theoretical density.

TABLE I

| | Hot Roller | | | | |
|---|---|---|---|---|---|
| | Temperature | Flow rate | Loading | Thickness | Porosity |
| Example | (° C.) | (mL/min) | (g) | (μm) | (%) |
| 1. | 130 | 2 | 0.02501 | 166 | 65.7 |
| 2. | 60 | 2 | 0.02268 | 107 | 49.5 |
| 3. | 60 | 4 | 0.03431 | 164 | 49.9 |
| 4. | 70 | 2 | 0.01932 | 109 | 59.8 |
| 5. | 70 | 2 | 0.02303 | 120 | 55 |
| 6. | 70 | 4 | 0.0186 | 83 | 47.7 |

Results:

The preliminary process data shown in Table I demonstrates that the surface of the as-deposited material is as smooth as a blade coated film when the hot roller temperature is set at 60 degrees Celsius for spraying a slurry having a solids content of about 65 wt. % (e.g., Examples 2 and 3). As shown by Example 3, the porosity is around 49% with 65 wt. % solid content slurry, 60 degrees hot roller for spray with 4 ml/min flow rate. As shown by Example 2, the porosity is around 50% with 65 wt. % solid content slurry pneumatic-sprayed at a flow rate of 2 ml/min. A porosity of around 55% with 59 wt. % solid content slurry has been achieved using Doctor blade coating techniques. It is believed that using a slurry mixture having a solids content of about 70 wt. % will result in a porosity lower than 47%.

While the foregoing is directed to implementations of the present invention, other and further implementations of the invention may be devised without departing from the basic scope thereof, and the scope thereof is determined by the claims that follow.

1. A method for forming an electrode structure, comprising:
spraying an electro-active material over a flexible conductive substrate;
transferring the flexible conductive substrate having the electro-active material deposited thereon over a first heated roller having a first temperature; and then
transferring the flexible conductive substrate having the electro-active material deposited thereon over a second heated roller having a second temperature, wherein the second temperature is greater than the first temperature and the electro-active material comprises a cathodically active material.

2. The method of claim 1, further comprising transferring the flexible conductive substrate having the electro-active material deposited thereon over a third heated roller having a third temperature after transferring the flexible conductive substrate over the second heated roller, wherein the third temperature is greater than the second temperature.

3. The method of claim 2, wherein the first temperature is between about 60 degrees Celsius and about 90 degrees Celsius and the second temperature is between about 90 degrees Celsius and about 100 degrees Celsius or between about 120 degrees Celsius and about 130 degrees Celsius.

4. The method of claim 3, wherein the third temperature is between about 120 degrees Celsius and about 130 degrees Celsius.

5. The method of claim 4, wherein the transferring the flexible conductive substrate having the electro-active material deposited thereon over a first heated roller and the spraying an electro-active material over a flexible conductive substrate occur simultaneously.

6. The method of claim 5, wherein the spraying an electro-active material over a flexible conductive substrate is performed using a hydraulic spray technique, an atomizing spray technique, an electrospray technique, a pneumatic spray technique, a plasma spray technique, and a flame spray technique.

7. The method of claim 6, wherein the electro-active material is part of a slurry mixture further comprising a binding agent and a solvent.

8. The method of claim 7, wherein the slurry mixture has a solids content of from about 50 wt. % to about 70 wt. % based on the total weight of the slurry mixture.

9. The method of claim 8, wherein the slurry mixture has a solids content of from about 65 wt. % to about 70 wt. % based on the total weight of the slurry mixture.

10. The method of claim 8, wherein the slurry mixture is delivered toward the flexible conductive substrate at a flow rate from about 0.1 ml/minute and about 10 ml/minute.

11. The method of claim 10, wherein the slurry mixture is delivered toward the flexible conductive substrate at a flow rate from about 0.5 ml/minute and about 4 ml/minute.

12. The method of claim 11, wherein the substrate travels at a rate from about 10 meters/minute to about 20 meters/minute.

13. The method of claim 12, wherein the flexible conductive substrate comprises aluminum.

14. The method of claim 13, wherein the cathodically active material is selected from the group consisting of: lithium cobalt dioxide (LiCoO₂), lithium manganese dioxide (LiMnO₂), titanium disulfide (TiS₂), LiNixCo₁₋₂ₓMnO₂, LiMn₂O₄, LiFePO₄, LiFe₁₋ₓMgPO₄, LiMoPO₄, LiCoPO₄, Li₃V₂(PO₄)₃, LiVOPO₄, LiMP₂O₇, LiFe_{1.5}P₂O₇, LiVPO₄F, LiAlPO₄F, Li₅V(PO₄)₂F₂, Li₅Cr(PO₄)₂F₂, Li₂CoPO₄F, Li₂NiPO₄F, Na₅V₂(PO₄)₂F₃, Li₂FeSiO₄, Li₂MnSiO₄, Li₂VOSiO₄, LiNiO₂, and combinations thereof.

15. The method of claim 14, wherein the slurry mixture further comprises:
a binding agent selected from the group consisting of: styrene butadiene rubber (SBR), carboxymethylcellulose (CMC), polyvinylidene fluoride (PVDF) and combinations thereof; and
a solvent.
